(19) United States
(12) Patent Application Publication
(10) Pub. No.: US 2013/0065003 A1
(43) Pub. Date: Mar. 14, 2013

(54) METHOD FOR PRODUCING A COMPOSITE FILM FOR A TUBULAR BAG AND TUBULAR BAG

(71) Applicants: Joerg P. Weltert, Wallisellen (CH); Derk Ekenhorst, Osnabruck (DE)

(72) Inventors: Joerg P. Weltert, Wallisellen (CH); Derk Ekenhorst, Osnabruck (DE)

(73) Assignee: ROBERT BOSCH GMBH, Stuttgart (DE)

(21) Appl. No.: 13/698,939

(22) PCT Filed: May 26, 2011
(86) PCT No.: PCT/EP11/58630

§ 371 Date: Nov. 19, 2012

(30) Foreign Application Priority Data
May 27, 2010 (DE) 102010029357.1

(51) Int. Cl. B32B 37/16

(52) U.S. Cl. CPC B32B 37/16
USPC 428/35.7; 156/256; 156/182

(57) ABSTRACT

The invention relates to a method for producing a composite film (15; 15a; 15b; 15c) for a tubular bag (1), wherein the composite film (15; 15a; 15b; 15c) consists of a plurality of layers (16; 16a; 16b, 17, 18; 18a, 23, 24; 24a, 25; 25a; 26, 27; 29) that are interconnected, wherein at least one of the layers (16; 16a; 16b, 17, 18; 18a, 23, 24; 24a, 25; 25a; 26, 27; 29) is designed as a barrier layer (16; 16a; 16b, 17, 18; 18a; 27; 29), and wherein at least one further layer (23, 24; 24a, 25; 25a, 26; 29) is provided that has a recess (30; 30a). According to the invention, the composite film (15; 15a; 15b; 15c) is produced by connecting a first layer structure (19) to a second layer structure (22; 22a), the second layer structure (22; 22a) comprises the at least one further layer (23, 24; 24a, 25; 25a, 26; 29), and the recess (30; 30a) in the at least one further layer (23, 24; 24a, 25; 25a, 26; 29) is produced prior to the connection to the second layer structure (22; 22a) in the second layer structure (22; 22a).

### BACKGROUND OF THE INVENTION

The invention relates to a method for producing a composite film for a tubular bag. The invention furthermore relates to a tubular bag using a composite film produced using a method according to the invention.

Such a method in which a composite film is provided with a cutout in the region of at least one layer is known from US 2003/0128899 A1. In the known production method, the cutouts which are intended to facilitate opening of the tubular bag by means of a drinking straw are subsequently formed in a prefabricated composite film comprising all the layers. A drawback of this method is the relatively complicated control of the laser, since the cutouts may only be formed in the layers of the composite film intended for this purpose, and damage to barrier layers must for example be avoided. This restricts the use of the described method and the materials which may be used for the composite film.

U.S. Pat. No. 5,482,176 furthermore discloses a packaging container which consists of a material formed in multiple layers, which comprises cardboard coated on the inside and the outside. The outer coating of the cardboard is provided with a cutout in the region of an opening device. The opening device is furthermore joined to the outer coating of the cardboard by means of an additional adhesive layer. Due to the use of cardboard, the known composite film is not suitable for use in a flexible bag package in the form of a tubular bag.

WO 2007/149231 A2 discloses a composite film which is suitable for use with an opening device on a tubular bag. In the known composite film, a hole for the opening device is stamped out, which hole is covered on the inside of the packaging container formed from the composite film with an additional material layer serving as a barrier layer in the form of a packaging material strip. From the other side of the composite film, which takes the form of a laminated film, the opening device is brought into line with the stamped hole and joined over an annular region to the packaging material strip. The opening device comprises a cutting device in the form of cutting teeth which perforates or tears the additional material layer in order to open the packaging container, in order, for example, to allow pouring of a liquid from the packaging container constructed as a tubular bag.

Such packaging containers in the form of tubular bags are produced on what are known as “form/fill/seal machines”. The holes for the opening devices are here cut or stamped out from the composite film supplied as a continuous packaging material web at a separate input section. The portions of material which form the subsequent barrier layers are then heat-sealed, from what will subsequently be the inside of the packaging container, onto the packaging material web.

The method involving the use of the latter-stated composite film is relatively complex due to the necessary stamping of the packaging material web and subsequent heat-sealing of the barrier layers, since an additional stamping apparatus and a heat-sealing apparatus are required. In particular, it may here be problematic that, in the event of malfunctioning of the stamping apparatus or the heat-sealing apparatus, the entire production or filling process of the form/fill/seal machine has to be interrupted for an extended period. It should furthermore be considered disadvantageous that stamping out the hole and subsequently reclosing the hole with the material layer of the packaging material strip results in tearing or destruction of the original barrier layers. This constitutes a potential weak point to the extent that the manufacture of the original barrier function requires a high-quality packaging material strip (with regard to material and thickness) and elevated process reliability.

### SUMMARY OF THE INVENTION

In the light of the stated prior art, the object of the invention is to develop a method for producing a composite film for a tubular bag in such a manner that said method combines economically viable production of the composite film with maximum possible flexibility with regard to the materials used for the composite film and high precision creation of the cutouts in order to ensure the greatest possible barrier action and process reliability in the production of the composite film. The concept on which the invention is based is to form the composite film by using two multilayer structures which are joined to one another, one of which multilayer structures contains the cutouts for opening devices, wherein the layers of the composite film take the form of flexible layers.

In terms of manufacturing technology, the cutouts may be produced highly precisely and with relatively low costs using a stamping or laser process.

In particular, it is provided that the at least one further layer comprises at least one first supporting layer. In other words, this means that the cutout is created in the region of the first supporting layer. This is because it is not generally possible to cut through such a supporting layer, which consists of plastics, with conventional opening devices with cutting teeth consisting of plastics since known supporting layers exhibit relatively high strength or toughness.

The invention also comprises a tubular bag with an opening device and a composite film produced by a method according to the invention, wherein the opening device is joined in alignment with the cutout of the composite film, and wherein the joint between the opening device and the composite film takes the form of an ultrasound weld joint or a heat-sealed joint.

Thanks to the production apparatus which is of relatively simple construction due to the omission of stamping apparatuses for forming through-holes and of additional packaging material strips forming the barrier layer, such a tubular bag may be produced relatively inexpensively and exhibits good barrier properties. Such a method for joining the opening device and the composite film furthermore has the advantage that it may be carried out without any additional auxiliary substances, such as adhesive, and is relatively simple to control in terms of manufacturing technology.

### BRIEF DESCRIPTION OF THE DRAWINGS

Further advantages, features and details of the invention are revealed by the following description of a preferred exemplary embodiment with reference to the drawings, in which:

FIG. 1 is a simplified side view of a tubular bag having an opening device and filled with package contents,

FIG. 2 is an opening device in a perspective representation,

FIG. 3 and FIG. 4 in each case show sections through a composite film with opening devices arranged on the composite film,

FIG. 5 is a simplified representation to explain the production method of a composite film for producing tubular bags according to FIG. 1,

FIG. 6 is a simplified representation of a packaging machine for manufacturing tubular bags filled with package contents,

FIG. 7 to FIG. 11 show a simplified representation to explain the production method of a first alternative composite film and

FIG. 12 to FIG. 14 show a simplified representation to explain the production method of a second alternative composite film.

### DETAILED DESCRIPTION

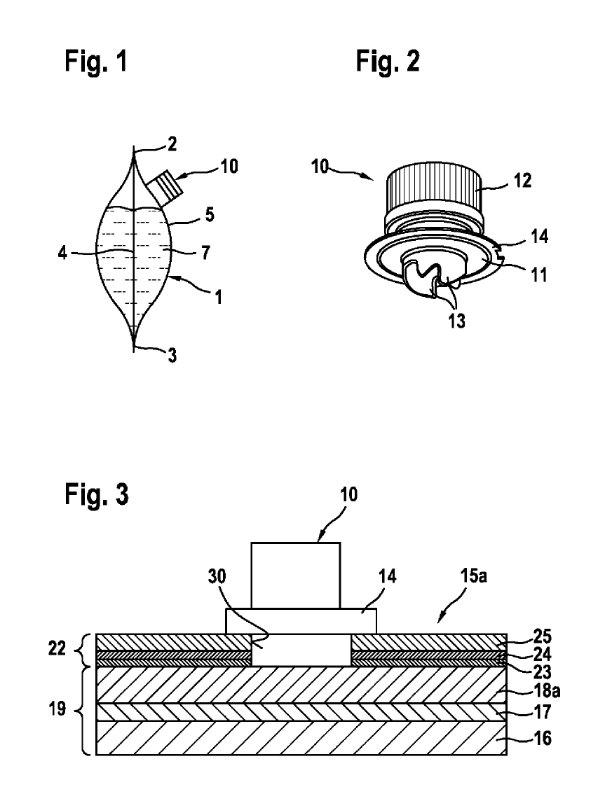

FIG. 1 is a simplified diagram of a packaging container taking the form of a tubular bag 1. The tubular bag 1 comprises an upper transverse seam 2, a lower transverse seam 3 and at least one longitudinal seam 4. The tubular bag 1 may also be provided in the bottom or top zone respectively with a pleated bottom closure or pleated top closure, for example to provide stability of the tubular bag 1 or to enable a particular visual appearance.

An opening device 10 is arranged in the outer wall 5 of the tubular bag 1, preferably in the upper region of the tubular bag 1, but below the upper transverse seam 2. As may most readily be seen with reference to FIG. 2, the opening device 10, which preferably consists of plastics and is produced by injection molding, comprises a base member 11 which is joined to a removable lid closure 12. The screw-fastening lid closure 12 cooperates with cutting teeth 13 which, on rotation of the lid closure 12, enter into operative connection with the outer wall 5 of the tubular bag 1 in order to cut through or form a passage in the latter and so permit removal of a product 7 located in the tubular bag 1, for example a liquid product 7, such as milk, fruit juices or the like. The base member 11 furthermore comprises a peripheral connection flange 14 for fastening the opening device 10 to the tubular bag 1.

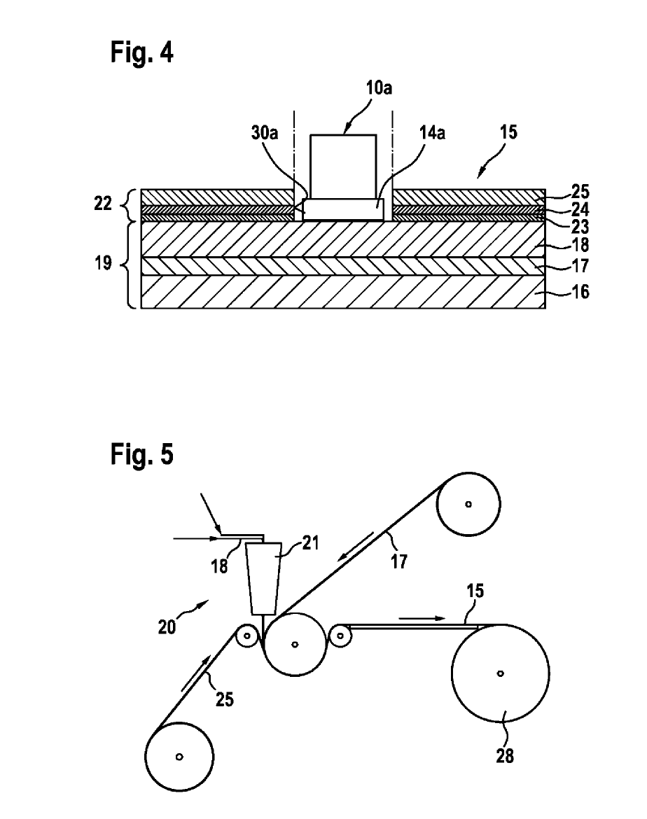

The material of the tubular bag 1 consists of a composite film consisting of flexible layers, in particular a laminated composite film 15, 15a, and, according to FIGS. 3 and 4 by way of non-limiting example, has a structure which firstly has an LDPE heat-sealing layer 16 (LDPE=low density polyethylene) on the inside of the tubular bag 1. Following the LDPE heat-sealing layer 16, there is an aluminum layer 17. The aluminum layer 17 is followed by an MDPE layer 18 (MDPE=medium density polyethylene) joined to the aluminum layer 17 by an extrusion method (FIG. 4). In the laminated composite film 15a according to FIG. 3, an adhesive layer 18a is used instead of the MDPE layer 18.

The first multilayer structure 19, which consists of the LDPE heat-sealing layer 16, the aluminum layer 17 and the MDPE layer 18 or the adhesive layer 18a, said first multilayer structure acting as barrier layer or barrier layer assembly, is joined to a second multilayer structure 22 by means of a manufacturing apparatus 20 shown in simplified form in FIG. 5 which comprises a coextrusion apparatus 21. The second multilayer structure 22 comprises a primer layer 23, a print layer 24 and a supporting layer 25. The second multilayer structure 22 is joined to the first multilayer film structure 19 by means of the manufacturing apparatus 20 for laminated composite film 15 or 15a shown in FIG. 5 and wound up to form a packaging material roll 28.

It is essential to the invention for the second multilayer structure 22 in each case to comprise a cutout 30, 30a in the regions in which the opening devices 10 are arranged during manufacture of the tubular bags 1. The cutouts 30, 30a are here produced or created in the second multilayer structure 22 during the production process for the second multilayer structure 22 by an appropriate manufacturing apparatus, in particular by a stamping apparatus or laser cutting apparatus (not shown). In particular, it is essential for the cutouts 30 to be created at least in the region of the supporting layer 25, since the supporting layer 25 consists of OPP (oriented polypropylene), PET or a material which is capable of withstanding similar mechanical loads or which exhibits strength/toughness such that the cutting teeth 13 of the opening device 10 are not (usually) capable of cutting through said layer.

The packaging material roll 28 with the rolled up laminated composite film 15, 15a therefore already comprises the cutouts 30 for the opening devices 10, wherein it is essential for the cutouts 30 to be arranged on the laminated composite film 15, 15a preferably at specific, uniform distances corresponding to the size of the tubular bags 1 produced from the laminated composite film 15, 15a. The packaging material roll 28 can thus be processed without waste.

In the exemplary embodiment of the invention shown in FIG. 3, the cutout 30 is of a size which is smaller than the size or diameter of the connection flange 14 of the opening device 10. In this embodiment, the connection flange 14 is joined with the underside thereof to the supporting layer 25, which forms the subsequent outer wall 5 of the tubular bag 1. Joining preferably proceeds by means of an ultrasound welding apparatus or heat-sealing apparatus (not shown). Said apparatus joins the connection flange 14 of opening device 10 with an in particular radially peripheral joint seam such that the connection flange 14 is joined in leakproof manner to the supporting layer 25. FIG. 3 furthermore reveals that the opening device 10 or the base member 11 or the cutting edges 13 are not yet in operative connection with the first multilayer film structure 19. This does not occur until the tubular bag 1 is opened for removal of the product 7.

In the exemplary embodiment of the invention shown in FIG. 4, the cutout 30a is of a size or diameter which is larger than the size of the connection flange 14 of the opening device 10a. In this embodiment, the opening device 10a is applied or joined with its connection flange 14a to the MDPE layer 18, preferably by an ultrasound welding apparatus (not shown).

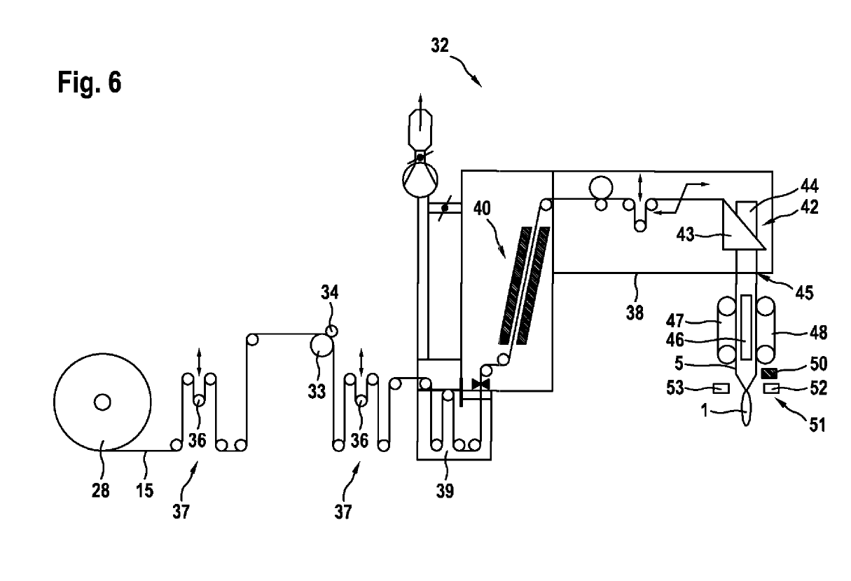

FIG. 6 is a simplified diagram of a packaging installation 32 for producing tubular bags 1 from a packaging material roll 28 and filling the tubular bags 1. The packaging installation 32 comprises transport rollers 33, 34, by means of which the packaging material roll 28 is unrolled. A plurality of compensating apparatuses 37 comprising dancer rollers 36 can also be seen, these enabling compensation between cyclic advance and continuous advance of the material from the packaging material roll 28 in different regions of the packaging machine 32. After unwinding, the laminated composite film 15 passes into the region of a machine housing 38 of the packaging machine 32, wherein a sterile atmosphere or sterile conditions prevail inside the machine housing 38. A sterilizing bath 39 is arranged inside the machine housing 38, the bath containing for example liquid hydrogen peroxide for sterilizing the laminated composite film 15. The laminated composite film 15 is then dried by means of a drying apparatus 40 and supplied to a vertical form/fill/seal machine 42.

The form/fill/seal machine 42 comprises a forming collar 43 and a forming and filling tube 44, which is connected with storage means (not shown) for the product 7 to be filled. The forming and filling tube 44 passes through the machine housing 38 in the region of an outlet 45. From the region of the outlet 45, non-sterile conditions prevail in the region of the packaging machine 32. A longitudinal seam sealing apparatus 46 and two vacuum-assisted, cyclically operating outfeed belts 47, 48 are also shown in the lower region of the forming and filling tube 44. An application apparatus 50 for affixing the opening devices 10 to the outer wall 5 of the tubular bag 1 is also shown. The application apparatus 50, which is not shown in greater detail, substantially comprises the ultrasound welding apparatus already mentioned above and is preferably coupled to a storage magazine for the opening devices 10. It is essential here for the application apparatus 50 still to be arranged in the region of the forming and filling tube 44, such that when the opening devices 10 are affixed to the outer wall 5 of the subsequent tubular bag 1 the forming and filling tube 44 acts as a steady for the opening device 10, so as to permit the required application pressure of the connection flange 14 on the outer wall 5. It is furthermore essential for the application apparatus 50 to be located in the non-sterile region. This permits direct access (in the event of any possible) operating malfunctions of the application apparatus 50 without affecting the sterility of the upstream region of the packaging installation 32. There is furthermore no longer any need to sterilize the opening devices 10.

A transverse seam sealing apparatus 51 is arranged below the forming and filling tube 44, said apparatus comprising two transverse seam sealing bars 52 and 53 which are displaceable towards one another, and (not shown) cut-off blades for dividing in each case one tubular bag 1 from the packaging material tube. In the manufacturing process for the tubular bags 1, it is essential for the application apparatus 50 to align the opening devices 10 with the cutouts 30, 30a in such a manner that they are congruently aligned with the cutouts 30, 30a.

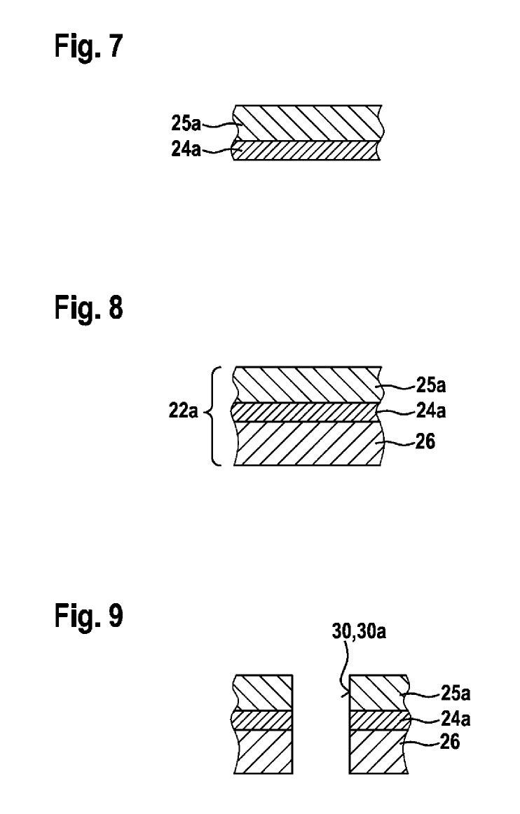

FIGS. 7 to 11 show the production process for a laminated composite film 15b which may alternatively likewise be used instead of the laminated composite films 15, 15a. In this case, in accordance with FIG. 7, the supporting layer 25a consisting of PET or OPP is printed on the reverse thereof with print layer 24a comprising a printed image. Then, in accordance with FIG. 8, the print layer 24a is joined, on the opposite side to the supporting layer 25a, by an adhesion or extrusion lamination method to a layer 26, for example of polyamide (PA), which is capable of withstanding mechanical loads. The supporting layer 25a, the print layer 24a and the layer 26 thus form the second multilayer structure 22a.

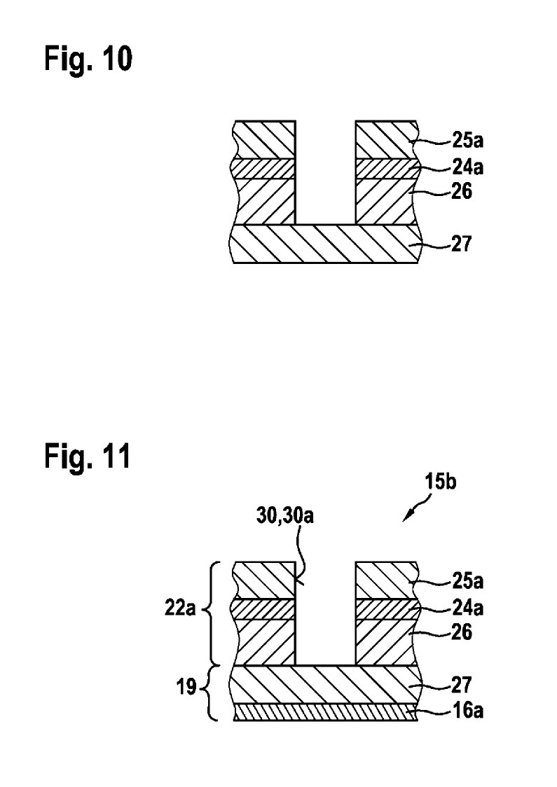

Then, in accordance with FIG. 9, the cutouts 30, 30a are created in the second multilayer structure 22a. The resultant second multilayer structure 22a is then joined in accordance with FIG. 10 to a prefabricated interlayer 27. This proceeds by extrusion lamination. The interlayer 27 here comprises for example polyester, polyamide, polypropylene with or without barrier coatings, mono- or multilayer films, which are produced by blowing or casting methods or alternatively an aluminum foil with a thickness of between 5 μm and 15 μm. In a final step in accordance with FIG. 11, the interlayer 27 is provided in a further extrusion method, on the opposite side to the second multilayer structure 22a, with the heat-sealing layer 16a, generally consisting of polyethylene, which is required for formation of the tubular bag 1. The heat-sealing layer 16a may here be coated by coextrusion with different densities of polyethylene for controlling adhesion and heat-sealing characteristics.

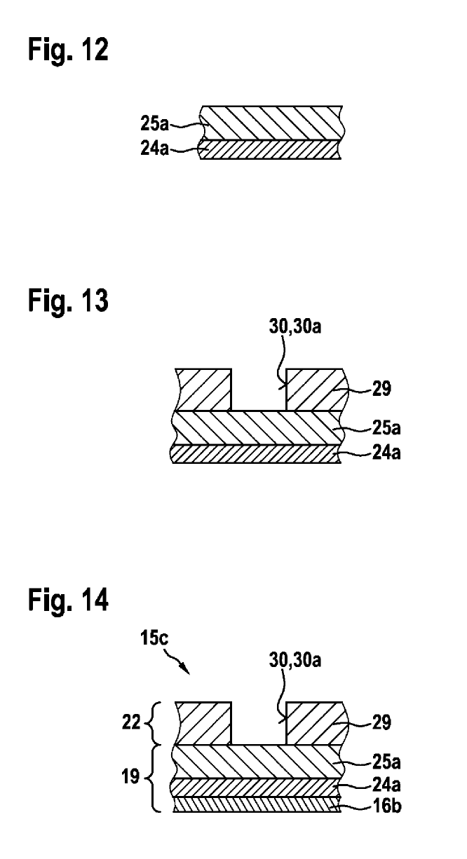

In the production process shown in FIGS. 12 to 14 for the laminated composite film 15c, in a first step according to FIG. 12 the supporting layer 25a consisting of PET or OPP is printed on the reverse thereof with the print layer 24a comprising a printed image. Then, according to FIG. 13, the supporting layer 25a is joined, on the side remote from the print layer 24a, by an adhesion or extrusion lamination method to a prefabricated layer 29, taking the form of a mono- or multi-ply layer, which is produced by a blowing method and is hence relatively strong. Prefabrication here also comprises the formation of the cutouts 30, 30a. The layer 29 may exhibit the barrier properties necessary for product protection by the use of suitable plastics, such as for example EVOH or PVDC among others. In a third step shown in FIG. 14, the print layer 24a is provided with the heat-sealing layer 16b. This preferably proceeds by means of casting/extrusion coating. Flat film dies are used here for producing the heat-sealing layer 16b. In this manner, shortly after emerging from the die, the polymer melt comes into contact with chill rolls and the supporting material (supporting layer 25a and print layer 24a), so immediately freezing in the molecular chain structure and keeping it short. This ensures very good cuttability, which facilitates opening of the tubular bag 1 by the opening device 10, 10a. Instead of the described casting/extrusion, it is also possible to join the supporting material (supporting layer 25a and print layer 24a) to the layer 29 by an adhesion lamination method.

1. A method for producing a composite film (15; 15a; 15b; 15c) for a tubular bag (1), wherein the composite film (15; 15a; 15b; 15c) includes consists of a plurality of layers joined to one another (16; 16a; 16b, 17, 18; 18a, 23, 24; 24a, 25; 25a; 26, 27; 29), wherein at least one of the layers (16; 16a; 16b, 17, 18; 18a, 23, 24; 24a, 25; 25a; 26, 27; 29) takes the form of a barrier layer (16; 16a; 16b, 17, 18; 18a; 27; 29), and wherein at least one further layer (23, 24; 24a, 25; 25a, 26; 29) is provided which comprises a cutout (30; 30a), characterized in that the composite film (15; 15a; 15b; 15c) is produced by joining a first multilayer structure (19) to a second multilayer structure (22; 22a), in that the second multilayer structure (22; 22a) comprises the at least one further layer (23, 24; 24a, 25; 25a, 26; 29), and in that the cutout (30; 30a) in the at least one further layer (23, 24; 24a, 25; 25a, 26; 29) is produced in the second multilayer structure (22; 22a) prior to joining to the second multilayer structure (22; 22a).

2. The method as claimed in claim 1, characterized in that a plurality of cutouts (30; 30a) arranged at uniform distances from one another are produced in the composite film (15; 15a; 15b; 15c).

3. The method as claimed in claim 1, characterized in that the cutout (30; 30a) is created by a stamping or laser process.

4. The method as claimed in claim 1, characterized in that the at least one further layer comprises at least one supporting layer (25; 25a).

5. The method as claimed in claim 1, characterized in that the composite film (15a) is applied on a side of the barrier layer which faces the cutout (30a) on an adhesive layer (18a).

6. The method as claimed in claim 1, characterized in that one of an aluminum layer (17) and an interlayer (27) comprising polyester, polyamide or polypropylene with a barrier coating is used as the barrier layer which is part of the first multilayer structure (19) of the composite film (15; 15a; 15b).

7. The method as claimed in claim 1, characterized in that the production of the composite film (15; 15a; 15b; 15c) involves an extrusion method.

8. The method as claimed in claim 4, characterized in that a layer (26) of polyamide capable of withstanding elevated mechanical loads is used for the second multilayer film structure (22a), wherein the layer (26) is joined to the supporting layer (25a) by an adhesion or extrusion method.

9. The method as claimed in claim 4, characterized in that a layer (29) capable of withstanding elevated mechanical loads is used for the second multilayer structure (22).

10. The method as claimed in claim 9, characterized in that the layer (29) capable of withstanding elevated mechanical loads takes the form of a mono- or multi-ply layer, and in that the layer (29) is joined by means of an adhesion or extrusion method to a print layer (24a), which is in turn joined to the supporting layer (25a).

11. The method as claimed in claim 9, characterized in that the layer (29) contains EVOH (ethylene vinyl alcohol) or PVDC (polyvinylidene chloride) in order to provide a barrier function.

12. The method as claimed in claim 10, characterized in that a heat-sealing layer (16b) is applied onto the print layer (24a).

13. The method as claimed in claim 12, characterized in that the heat-sealing layer (16b) is applied by casting/extrusion coating.

14. A packaging container taking the form of a tubular bag (1), with a composite film (15; 15a; 15b; 15c), the composite film includes a plurality of layers joined to one another (16; 16a; 16b, 17, 18; 18a, 23, 24; 24a, 25; 25a; 26, 27; 29), wherein at least one of the layers (16; 16a; 16b, 17, 18; 18a, 23, 24; 24a, 25; 25a; 26, 27; 29) takes the form of a barrier layer (16; 16a; 16b, 17, 18; 18a; 27; 29), and wherein at least one further layer (23, 24; 24a, 25; 25a, 26; 29) is provided which comprises a cutout (30; 30a), characterized in that the composite film (15; 15a; 15b; 15c) is produced by joining a first multilayer structure (19) to a second multilayer structure (22; 22a), in that the second multilayer structure (22; 22a) comprises the at least one further layer (23, 24; 24a, 25; 25a, 26; 29), and in that the cutout (30; 30a) in the at least one further layer (23, 24; 24a, 25; 25a, 26; 29) is produced in the second multilayer structure (22; 22a) prior to joining to the second multilayer structure (22; 22a); and
an opening device (10; 10a) which is joined to the tubular bag (1).

15. The tubular bag (1) as claimed in claim 14, characterized in that the opening device (10; 10a) is joined in alignment with the cutout (30; 30a) of the composite film (15; 15a; 15b; 15c), and in that a joint between the opening device (10;
10a) and the composite film (15; 15a; 15b; 15c) takes the form of an ultrasound weld joint or a heat-sealed joint.

16. The method as claimed in claim 4, wherein the at least one supporting layer (25; 25a) includes oriented polypropylene (OPP) or polyethylene terephthalate (PET).

17. The method as claimed in claim 9, wherein the layer (29) capable of withstanding elevated mechanical loads is produced by a blowing method.
